(19) United States
(12) Patent Application Publication
(10) Pub. No.: US 2024/0204618 A1
(43) Pub. Date: Jun. 20, 2024

(54) ROTARY MACHINE

(71) Applicant: MEIDENSHA CORPORATION, Tokyo (JP)

(72) Inventors: Yuki UGAMOCHI, Tokyo (JP); Kazuya OGURA, Tokyo (JP); Kyoichi NOMURA, Tokyo (JP)

(73) Assignee: MEIDENSHA CORPORATION, Tokyo (JP)

(21) Appl. No.: 18/288,756

(22) PCT Filed: Feb. 9, 2022
(86) PCT No.: PCT/JP2022/005164

§ 371 Date: Oct. 27, 2023

(30) Foreign Application Priority Data
Apr. 30, 2021 (JP) 2021-077309

(51) Int. Cl. H02K 9/18; H02K 1/20; H02K 5/20; H02K 21/14

(52) U.S. Cl. CPC H02K 9/18; H02K 1/20; H02K 5/207; H02K 21/14

(57) ABSTRACT

A motor 1 includes a stator 3, a rotor 2, and a housing 52. The housing 52 includes a one-side space 52a, an other-side space 52b, a one-side communication hole 52c, and an other-side communication hole 52d. The one-side space 52a and the other-side space 52b communicate with each other via a gap G, the one-side communication hole is connected to a first airflow generator 64, and the other-side communication hole is connected to a second airflow generator 65. The motor 1 includes a forced inflow hole 52c1 connected to the first airflow generator 64 and a natural exhaust hole 52c2 through which air is naturally exhausted as the one-side communication hole, and includes a forced exhaust hole 52d1 connected to the second airflow generator 65 and a natural intake hole 52d2 through which air is naturally sucked into inside of the other-side space 52b as the other-side communication hole.

### TECHNICAL FIELD

The present invention relates to a rotary machine such as a motor and a generator (a dynamo).

### BACKGROUND ART

Conventionally, there is known a rotary machine that includes a stator, a rotatable rotor disposed in a hollow space of the stator, and a housing that accommodates the stator and the rotor, and cools the stator and the rotor by air sent from outside to inside of the housing.

For example, a rotary electric machine as a rotary machine described in Patent Literature 1 includes two spaces in a frame as a housing. In Patent Literature 1, one of the two spaces described above is located on one side in an axial direction relative to the rotor disposed in the housing, and thus is referred to as a one-side space. Further, the other space is located on the other side in the axial direction relative to the rotor disposed in the housing, and thus is referred to as an other-side space. Each of the one-side space and the other-side space communicates with each other in the axial direction through a gap (gap) formed between an inner peripheral surface of the stator and an outer peripheral surface of the rotor disposed in the hollow space of the stator.

The housing of the rotary electric machine described above includes a one-side communication hole that allows the outside and the inside one-side space to communicate with each other, and an other-side communication hole that allows the outside and the inside other-side space to communicate with each other. A one-side air circulation device as a first airflow generator and an other-side air circulation device as a second airflow generator are disposed outside the housing. The one-side air circulation device including a blower or the like sends air into the one-side space in the housing through the one-side communication hole provided in the housing. Further, the other-side air circulation device including a blower or the like sends air into the other-side space in the housing through the other-side communication hole provided in the housing. Each of the stator and the rotor in the housing is cooled by the air sent into the one-side space and the air sent into the other-side space.

The rotary electric machine has a characteristic configuration in which air pressure in the one-side space is set higher than the air pressure in the other-side space by setting an air supply amount per unit time by the one-side air circulation device larger than the air supply amount per unit time by the other-side air circulation device. According to Patent Literature 1, with such a configuration, it is possible to cool a central portion in the axial direction of each of the stator and the rotor by generating an airflow from the one-side space toward the other-side space through the gap described above.

### CITATION LIST

### Patent Literature

Patent Literature 1: JP 2020-145899 A

### SUMMARY OF INVENTION

### Technical Problem

However, in such a configuration, since the amount of the air sent into the housing is reduced as compared with a configuration in which the air supply amount by the other-side air circulation device is set to the same extent as the air supply amount by the one-side air circulation device, there is a problem that cooling efficiency is lowered.

The present invention has been made in view of the above background, and an object thereof is to provide a rotary machine capable of cooling the central portion in the axial direction of each of the stator and the rotor by an airflow in the gap without lowering the cooling efficiency.

### Solution to Problem

In order to achieve the above object, the present invention provides a rotary machine that includes a stator, a rotatable rotor disposed in a hollow space of the stator, and a housing that accommodates the stator and the rotor, the housing includes: a one-side space that is disposed on one side in an axial direction relative to the rotor and communicates with a gap between an inner peripheral surface of the stator and an outer peripheral surface of the rotor; an other-side space that is disposed on the other side in the axial direction relative to the rotor and communicates with the gap; a one-side communication hole that allows outside of the housing and the one-side space to communicate with each other; and an other-side communication hole that allows the outside of the housing and the other-side space to communicate with each other, the one-side space and the other-side space communicates with each other through the gap, and each of the one-side communication hole and the other-side communication hole is connected to an airflow generator that generates an airflow, the rotary machine includes, as the one-side communication hole, a forced inflow hole that causes air outside the housing to forcibly flow into the inside of the one-side space by the first airflow generator, and a natural exhaust hole through which air inside the one-side space is naturally exhausted, and includes, as the other-side communication hole, a forced exhaust hole that causes the second airflow generator to forcibly exhaust air inside the other-side space, and a natural intake hole through which air outside the housing is naturally sucked into the inside of the other-side space.

### Advantageous Effects of Invention

According to the present invention, there is an excellent effect that the central portion in the axial direction of each of the stator and the rotor can be cooled by the airflow in the gap without lowering the cooling efficiency.

### BRIEF DESCRIPTION OF DRAWINGS

FIG. 1 is an exploded perspective view illustrating a main part of a motor according to one embodiment.

FIG. 2 is a cross-sectional view illustrating a longitudinal cross section of the motor.

FIG. 3 is a cross-sectional view illustrating a cross section (a cross section taken along a W-W′ line in FIG. 2) in the main part of the motor.

FIG. 4 is a view in which an arrow indicating a flow of air is added to the cross section shown in FIG. 2.

FIG. 5 is a view in which an arrow indicating a flow of air is added to the cross section shown in FIG. 3.

FIG. 6 is a cross-sectional view illustrating a longitudinal cross section of a motor 1 according to Example 1 together with a flow of air.

FIG. 7 is a cross-sectional view illustrating a longitudinal cross section of a motor 1 according to Example 2 together with a flow of air.

FIG. 8 is a cross-sectional view illustrating a longitudinal cross section of a motor 1 according to Example 3 together with a flow of air.

FIG. 9 is a cross-sectional view illustrating a longitudinal cross section of a motor according to Example 4 together with a flow of air.

FIG. 10 is a cross-sectional view illustrating a cross section of the main part of the motor together with the flow of air.

FIG. 11 is a cross-sectional view illustrating a longitudinal cross section of a motor according to Example 5 together with a flow of air.

FIG. 12 is a cross-sectional view illustrating a cross section of the main part of the motor together with the flow of air.

FIG. 13 is a cross-sectional view illustrating a longitudinal cross section of a main part of a motor according to a comparative example.

### DESCRIPTION OF EMBODIMENTS

Hereinafter, one embodiment of a motor as a rotary machine to which the present invention is applied will be described with reference to the drawings.

In the embodiment, for easy understanding, structures and elements other than the main part of the present invention will be described in a simplified or omitted manner. Further, in each drawing, the same elements are denoted by the same reference numerals. Note that, shapes, dimensions, and the like of the respective elements illustrated in the respective drawings are schematically illustrated, and do not indicate actual shapes, dimensions, and the like.

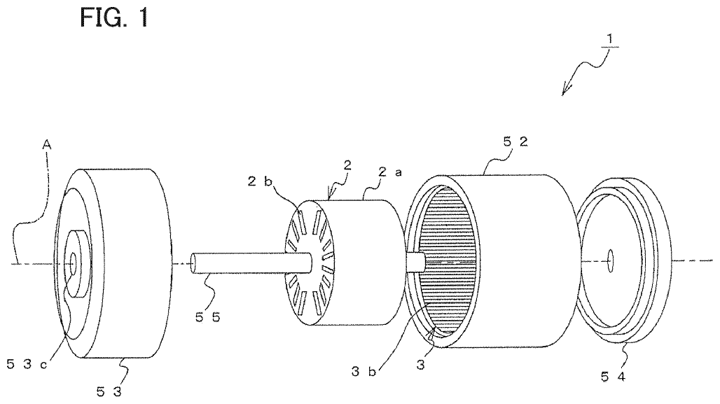

First, a basic configuration of a motor according to one embodiment will be described. FIG. 1 is an exploded perspective view illustrating a main part of a motor 1 according to one embodiment. The motor 1 is an inner rotor type motor, and includes a housing 52 in a cylindrical shape, a front cover 53, a rear cover 54, a shaft 55, a rotor (rotor) 2, and a stator (stator) 3. The rotor 2 is an interior permanent magnet type rotor. The motor 1 is an interior permanent magnet synchronous motor (IPMSM: interior permanent magnet synchronous motor) that is required to have a high output density, such as a vehicle motor.

The shaft 55 in an axial shape penetrates the rotor 2 in a cylindrical shape along a direction of a rotation axis A of the rotor 2 and is located on the rotation axis A. The shaft 55 is rotationally driven around the rotation axis A together with the rotor 2. The housing 52 in a cylindrical shape serves as a yoke and holds the stator 3 in a cylindrical shape on an inner peripheral surface. The housing 52 has openings at both ends in the direction of the rotation axis A. The rotor 2 is accommodated in a hollow space of the stator 3 held on the inner peripheral surface of the housing 52. The front cover 53 in a bottomed cylindrical shape is connected to a front side of the housing 52 with a bottom facing the front side in an axial direction (a direction parallel to the rotation axis A). With this connection, the front cover 53 allows the front side of the shaft 55 to pass through a shaft hole 53c provided at the bottom and blocks the opening on the front side of the housing 52.

The rear cover 54 is fixed to a rear-side end of the housing 52 so as to block the opening on a rear side of the housing 52.

The stator 3 is disposed on an outer peripheral side of the rotor 2 with an air gap therebetween. In other words, the stator 3 having a hollow structure includes the rotor 2 in the hollow space. The motor 1 sequentially switches a magnetic field of the stator 3 by current control of a coil to generate suction force or repulsion force with the magnetic field of the rotor 2, thereby rotationally driving the rotor 2 around the rotation axis A.

The rotor 2 includes a rotor core 2a and a plurality of permanent magnets 2b. The rotor core 2a of the rotor 2 is, for example, a cylindrical member formed by laminating punched silicon steel plates in the axial direction. An insulating adhesive is interposed between the individual silicon steel plates constituting the rotor core 2a, and the individual silicon steel plates are insulated from each other. The shaft 55 is fitted in a hollow space formed in an axial center portion of the rotor core 2a along the rotation axis A. In the motor 1, the shaft 55 is rotatably supported by a bearing (not illustrated).

The stator 3 includes a stator core. On an inner peripheral surface side of the stator core in a cylindrical shape, a plurality of teeth protruding inward in a radial direction around the rotation axis (A in FIG. 1) (hereinafter, simply referred to as a radial direction) are disposed. Each of the teeth is arranged at equal intervals in a circumferential direction around the rotation axis (hereinafter, simply referred to as a circumferential direction). Spaces between the teeth adjacent to each other form slots, respectively. A coil 3b is wound around the slot.

Among a plurality of coils 3b, U-phase coils 3b to which a U-phase power supply of a three-phase AC power supply is supplied are electrically connected to each other by U-phase connecting wires. Further, a plurality of V-phase coils 3b to which a V-phase power supply is supplied are electrically connected to each other by V-phase connecting wires. Further, a plurality of W-phase coils 3b to which a W-phase power supply is supplied are electrically connected to each other by W-phase connecting wires.

The motor 1 generates heat as it is driven. Heat generation is caused by iron loss in the stator core of the stator 3, copper loss in the coil 3b of the stator 3, iron loss in the rotor core 2a of the rotor 2, eddy current loss in the permanent magnet 2b of the rotor 2, copper loss in a secondary conductor (for example, the shaft 55) of the rotor 2, and the like.

Next, a motor according to a comparative example to which the present invention is not applied will be described. Note that, a characteristic configuration of the motor 1 according to the embodiment to which the present invention is applied will be described in detail later.

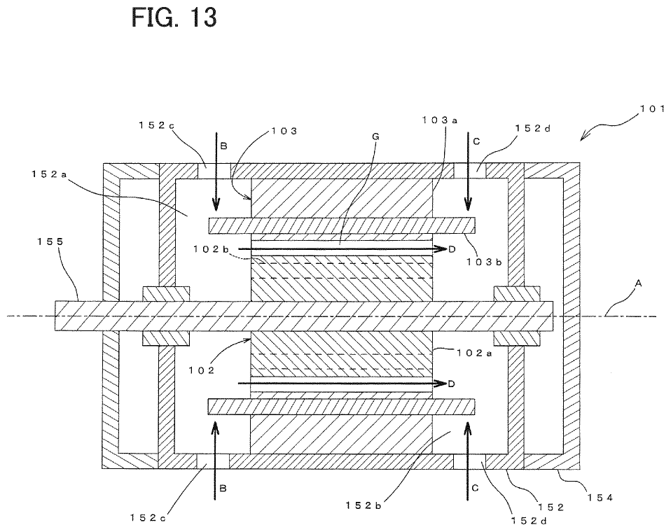

FIG. 13 is a cross-sectional view illustrating a longitudinal cross section of a main portion of a motor 101 according to a comparative example. The motor 101 according to the comparative example includes a rotor 102, a stator 103, a housing 152, a front cover 153, a rear cover 154, a shaft 155, and the like.

The housing 152 includes a one-side space 152a, an other-side space 152b, two one-side communication holes 152c, two other-side communication holes 152d, and the like. The one-side space 152a is disposed on one side (a left side in FIG. 13) in the axial direction relative to the rotor 102, and communicates with a gap (gap) G between the inner peripheral surface of a stator core 103a of the stator 103 and an outer peripheral surface of a rotor core 102a of the rotor 102. The other-side space 152b is disposed on the other side (a right side in FIG. 13) in the axial direction relative to the rotor 102 and communicates with the gap G. Each of the two one-side communication holes 152c allows the outside of the housing 152 and the one-side space 152a to communicate with each other in a state of being aligned in the radial direction with the one-side space 152a interposed therebetween. Each of the two other-side communication holes 152d allows the outside of the housing 152 and the other-side space 152b to communicate with each other in a state of being aligned in the radial direction with the other-side space 152b interposed therebetween.

A first airflow generator (not illustrated) and a second airflow generator including a blower and the like are disposed outside the housing 152. As indicated by an arrow B in the drawing, the first airflow generator sends air into the one-side space 152a in the housing 152 through each of the two one-side communication holes 152c. Further, As indicated by an arrow C in the drawing, the second airflow generator sends air into the other-side space 152b in the housing 152 through each of the two other-side communication holes 152d. An air supply amount per unit time by the second airflow generator is set to a value smaller than the air supply amount per unit time by the first airflow generator. With such a setting, when each of the two airflow generators is driven, air pressure in the one-side space 152a becomes higher than the air pressure in the other-side space 152b. As a result, as indicated by an arrow D in the drawing, an airflow flowing from the inside of the one-side space 152a into the other-side space 152b through the gap G is generated.

According to the motor 101 according to the comparative example having such a configuration, a central portion in the axial direction of each of the rotor 102 and the stator 103 can be cooled by the airflow flowing in the gap G. However, since the amount of air to be sent into the housing 152 is reduced as compared with a configuration in which the air supply amount by the second airflow generator is set to the same extent as the air supply amount by the first airflow generator, cooling efficiency is lowered. The rotary electric machine described in Patent Literature 1 described at the beginning also has a problem that the cooling efficiency is lowered for the same reason. Note that, Patent Literature 1 does not specifically describe how the air sent into the one-side space and the air sent into the other-side space are exhausted to the outside of the housing 52.

Next, a characteristic configuration of the motor 1 according to the embodiment will be described.

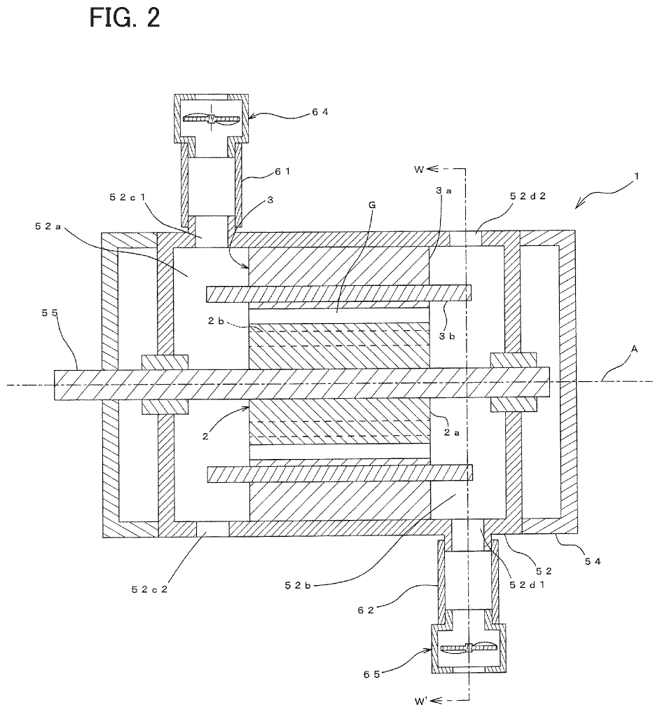

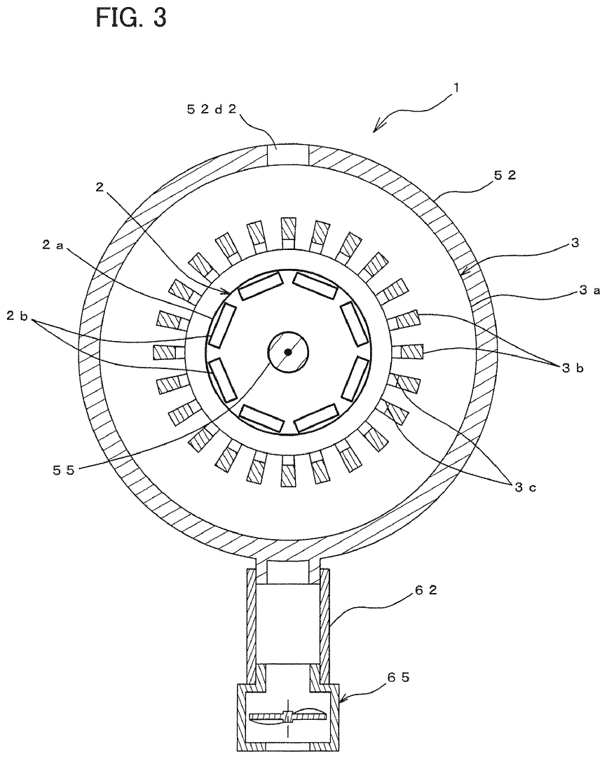

FIG. 2 is a cross-sectional view illustrating a longitudinal cross section of the motor 1 according to the embodiment. FIG. 3 is a cross-sectional view illustrating a cross section (a cross section taken along a W-W′ line in FIG. 2) in the main part of the motor 1. Note that, in these drawings, in order to facilitate visual recognition of the gap G between the inner peripheral surface of the stator 3 and the outer peripheral surface of the rotor 2, a width of the gap G (a distance between the inner peripheral surface of the stator 3 and the outer peripheral surface of the rotor 2) is illustrated to be larger than an actual width. Further, In FIG. 3, each part of the rotor 2 is indicated by a thick line in order to facilitate visual recognition of the gap G. Further, In FIG. 3, the plurality of teeth denoted by a reference sign 3c are provided in the stator core 3a of the stator 3.

The motor 1 includes a first airflow generator 64 and a second airflow generator 65 disposed outside the housing 52. These airflow generators include a blower, or a fan, or the like.

The housing 52 includes a one-side space 52a, an other-side space 52b, a forced inflow hole 52c1 as a one-side communication hole, a natural exhaust hole 52c2 as a one-side communication hole, a forced exhaust hole 52d1 as an other-side communication hole, a natural intake hole 52d2 as an other-side communication hole, and the like.

The one-side space 52a and the other-side space 52b communicate with each other through the gap G. The forced inflow hole 52c1 of the housing 52 is connected to an air supply port of the first airflow generator 64 by a first duct 61. Further, the forced exhaust hole 52d1 of the housing 52 is connected to a suction port of the second airflow generator 65 by a second duct 62. The first airflow generator 64 supplies air into the one-side space 52a through the forced inflow hole 52c1. The second airflow generator 65 sucks in the air in the other-side space 52b through the forced exhaust hole 52d1.

The forced inflow hole 52c1 as the one-side communication hole and the natural exhaust hole 52c2 as the one-side communication hole face each other in the radial direction with the one-side space 52a interposed therebetween. Further, the forced exhaust hole 52d1 as the other-side communication hole and the natural intake hole 52d2 as the other-side communication hole face each other in the radial direction with the other-side space 52b interposed therebetween.

Since the forced inflow hole 52c1 disposed on one side in the axial direction and the natural intake hole 52d2 disposed on the other side in the axial direction are disposed at the same position in the circumferential direction, they are located on the same imaginary line segment extending in the axial direction. Further, since the natural exhaust hole 52c2 disposed on one side in the axial direction and the forced exhaust hole 52d1 disposed on the other side in the axial direction are disposed at the same position in the circumferential direction, they are positioned on the same imaginary line segment extending in the axial direction.

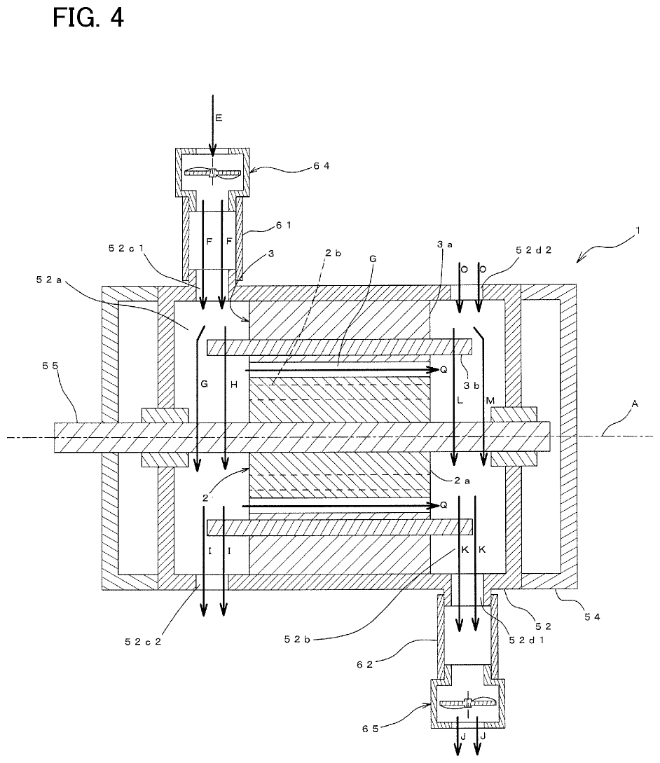

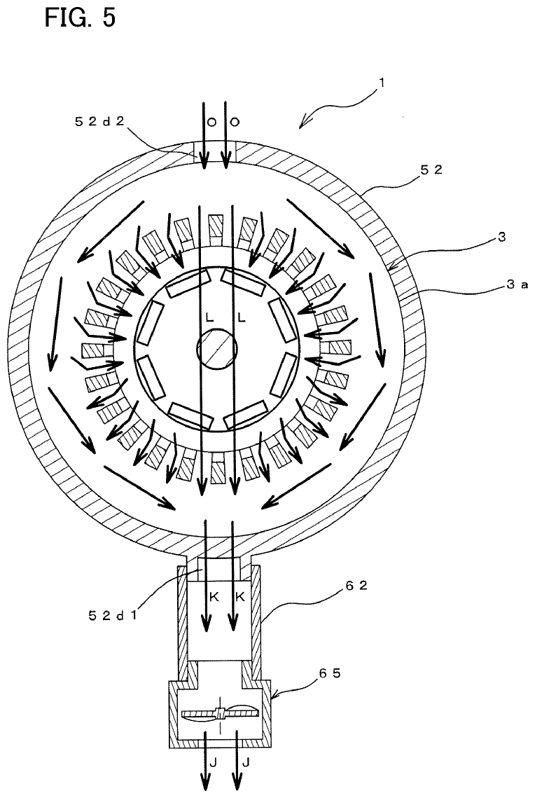

FIG. 4 is a view in which an arrow indicating a flow of air is added to the cross section shown in FIG. 2. Further, FIG. 5 is a view in which an arrow indicating a flow of air is added to the cross section shown in FIG. 3.

As shown in FIG. 4, at one side end of the stator 3 in the axial direction, the coil 3b of the stator 3 protrudes from one end of the stator core 3a in the axial direction toward one side. A coil portion protruding in this manner is hereinafter referred to as a one-side coil end portion of the coil 3b. The one-side coil end of the coil 3b is located in the one-side space 52a.

At the other side end of the stator 3 in the axial direction, the coil 3b of the stator 3 protrudes from the other end of the stator core 3a in the axial direction toward the other side. The coil portion protruding in this manner is hereinafter referred to as an other-side coil end portion of the coil 3b. The other-side coil end of the coil 3b is located in the other-side space 52b.

At one side end of the housing 52 in the axial direction (a left side end in FIG. 4), the first airflow generator 64 and the forced inflow hole 52c1 of the housing 52 communicate with each other via the first duct 61. The first airflow generator 64 sends air into the first duct 61 through its own air supply port while sucking in outside air through its own suction port. The air sent into the first duct 61 is forcibly caused to flow into the one-side space 52a of the housing 52 through the forced inflow hole 52c1 of the housing 52 as indicated by an arrow F. The forced inflow hole 52c1 is one of the two one-side communication holes that causes air outside the housing 52 to forcibly flow into the inside of the one-side space 52a by the first airflow generator 64.

In the one-side space 52a, most of the air forcibly sent through the forced inflow hole 52c1 moves from a side of the forced inflow hole 52c1 toward a side of the natural exhaust hole 52c2 as indicated by arrows G and H. Then, as indicated by an arrow I, most of the air is naturally exhausted from the inside of the one-side space 52a to the outside through the natural exhaust hole 52c2. The natural exhaust hole 52c2 is one of the two one-side communication holes through which air inside the one-side space 52a is naturally exhausted.

A portion on one side in the axial direction of each of the housing 52, the rotor 2, the stator 3, and the shaft 55 is cooled by the air flowing in the one-side space 52a.

At the other side end of the housing 52 in the axial direction (a right side end in FIG. 4), the second airflow generator 65 and the forced exhaust hole 52d1 of the housing 52 communicate with each other via the second duct 62. The second airflow generator 65 sucks in the air in the other-side space 52b of the housing 52 through its own suction port, the second duct 62, and the forced exhaust hole 52d1 of the housing 52 as indicated by an arrow K while exhausting air from its own air supply port as indicated by an arrow J. By this suction, air in the other-side space 52b is forcibly exhausted through the forced exhaust hole 52d1. Thereafter, the air is exhausted to the outside through the second duct 62 and the suction port and the air supply port of the second airflow generator 65. The forced exhaust hole 52d1 is one of the two other-side communication holes that causes the second airflow generator 65 to forcibly exhaust air inside the other-side space 52b.

In the other-side space 52b, when the air near the forced exhaust hole 52d1 is exhausted to the second duct 62 through the forced exhaust hole 52d1, most of the air moves from the side of the natural intake hole 52d2 toward the side of the forced exhaust hole 52d1 as indicated by arrows L and M. Due to negative pressure generated by this movement, air outside the housing 52 naturally flows into the other-side space 52b through the natural intake hole 52d2 of the housing 52. The natural intake hole 52d2 is one of the two other-side communication holes through which air outside the housing 52 is naturally sucked into the inside of the other-side space 52b.

A portion on the other side of each of the housing 52, the rotor 2, the stator 3, and the shaft 55 in the axial direction is cooled by the air flowing in the other-side space 52b. In particular, as shown in FIG. 5, the portion on the other side of the stator 3 is favorably cooled by the airflow coming into contact with the other side coil end portion in each of the plurality of coils 3b made of metal having high thermal conductivity. A portion on one side of the stator 3 is also favorably cooled for the same reason.

In the one-side space 52a of the housing 52, an air pressure gradient in which the air pressure gradually increases from the side of the natural exhaust hole 52c2 toward the side of the forced inflow hole 52c1 is generated by the air forcibly sent through the forced inflow hole 52c1. The air pressure in the one-side space 52a becomes positive pressure (positive pressure) over an entire area of the one-side space 52a. On the other hand, in the other-side space 52b of the housing 52, air is forcibly exhausted through the forced exhaust hole 52d1, so that an air pressure gradient in which the air pressure gradually decreases from the side of the natural intake hole 52d2 toward the side of the forced exhaust hole 52d1 is generated. The air pressure in the other-side space 52b becomes negative pressure (negative pressure) over the entire area of the other-side space 52b.

As described above, while the inside of the one-side space 52a has positive pressure over the entire area, the inside of the other-side space 52b has negative pressure over the entire area. Due to such a relationship of the air pressure, as indicated by the arrow G, air in the one-side space 52a flows from one side to the other side in the axial direction in the gap G and flows into the other-side space 52b. At this time, the air cools one end portion, the central portion, and the other end portion of the rotor 2 and the stator 3 in the axial direction. In other words, the motor 1 according to the embodiment can cool the center portions of the rotor 2 and the stator 3 in the axial direction by the air flowing in the gap G, similarly to the rotary electric machine described in Patent Literature 1.

The relationship in which the air pressure in the one-side space 52a becomes positive pressure as a whole while the air pressure in the other-side space 52b becomes negative pressure as a whole is established without being limited to a balance between the air supply amount by the first airflow generator 64 and the air supply amount (strictly, an air intake amount) an air intake amount by the second airflow generator 65. For this reason, in the motor 1 according to the embodiment, unlike the rotary electric machine described in Patent Literature 1, even when the air supply amount by the second airflow generator 65 is set to the same extent as the air supply amount by the first airflow generator 64, the airflow can be generated over the entire area in the axial direction in the gap G. Therefore, according to the motor 1 according to the embodiment, it is possible to cool the central portion of each of the stator 3 and the rotor 2 in the axial direction by the airflow in the gap G without causing a decrease in cooling efficiency caused by reducing the air supply amount by the second airflow generator 65 as compared with the air supply amount by the first airflow generator 64.

Note that, in the motor 1, an example has been described in which the front side in the axial direction (the side on which the shaft 55 protrudes) is one side in the present invention, and the rear side is the other side in the present invention, however, the front side may be the other side, and the rear side may be one side. Further, although an example has been described in which each of the first airflow generator 64 and the second airflow generator 65 is disposed outside the housing 52, the following may be adopted. In other words, two device housing spaces may be provided in the housing 52, the first airflow generator 64 may be disposed in one device housing space, and the second airflow generator 65 may be disposed in the other device housing space. In this case, one device housing space may be disposed adjacent to the one-side space 52a, the forced inflow hole 52c1 may be provided on a partition wall that partitions these spaces, and the other device housing space may be disposed adjacent to the other-side space 52b, and the forced exhaust hole 52d1 may be provided on the partition wall that partitions these spaces.

The forced inflow hole 52c1 and the natural intake hole 52d2 are disposed on one side in the radial direction (an upper side in FIG. 4). On the other hand, the natural exhaust hole 52c2 and the forced exhaust hole 52d1 are disposed on the other side in the radial direction (a lower side in FIG. 4). In such a configuration, in the one-side space 52a having positive pressure as a whole, a degree of the positive pressure near the one side end in the radial direction (near the forced inflow hole 52c1) is maximized, whereas the degree of the positive pressure near the other side end in the radial direction (near the natural exhaust hole 52c2) is minimized. Further, in the other-side space 52b having negative pressure as a whole, the degree of the negative pressure near the other side end in the radial direction (near the forced exhaust hole 52d1) is maximized, whereas the degree of the negative pressure near the one side end in the radial direction (near the natural intake hole 52d2) is minimized. Then, in the axial direction, an area where the degree of the positive pressure is maximum in the one-side space 52a and an area where the degree of the negative pressure is minimum in the other-side space 52b are adjacent to each other. In addition, an area where the degree of the positive pressure is minimum in the one-side space 52a and an area where the degree of the negative pressure is maximum in the other-side space 52b are adjacent to each other. As a result, an air pressure difference between the one-side space 52a and the other-side space 52b becomes substantially the same on one side and the other side in the radial direction. Therefore, according to the motor 1 according to the embodiment, an air flow rate from one side to the other side in the gap G can be made uniform in the circumferential direction.

Next, each example in which a more characteristic configuration is added to the motor 1 according to the embodiment will be described. Note that, the configuration of the motor 1 according to each example is the same as that of the embodiment unless otherwise specially noted below.

### Example 1

As can be seen from FIG. 4, in the motor 1 according to the embodiment, a dead space in which members related to the motor 1 are not disposed is generated on the side (specifically, the other side in the axial direction) of the first airflow generator 64. Further, a dead space is also generated on the side (specifically, one side in the axial direction) of the second airflow generator 65.

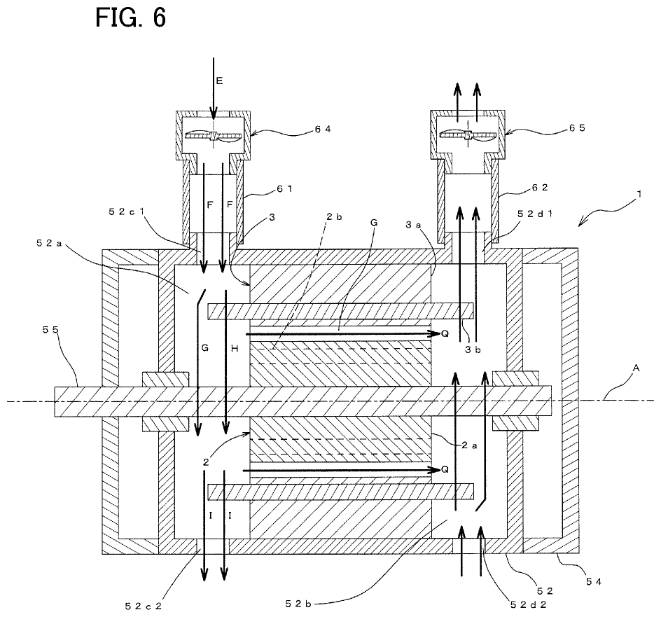

FIG. 6 is a cross-sectional view illustrating a longitudinal cross section of a motor 1 according to Example 1 together with a flow of air. In the motor 1 according to Example 1, the forced inflow hole 52c1 and the forced exhaust hole 52d1 are disposed on one side in the radial direction. On the other hand, the natural exhaust hole 52c2 and the natural intake hole 52d2 are disposed on the other side in the radial direction. With such an arrangement, the second airflow generator 65 is disposed on one side in the radial direction.

In such a configuration, by arranging the first airflow generator 64 and the second airflow generator 65 side by side in the axial direction, an installation area of the motor 1 including the airflow generator can be reduced as compared with a case where the airflow generator is disposed on one side and the other side in the radial direction (FIG. 2).

### Example 2

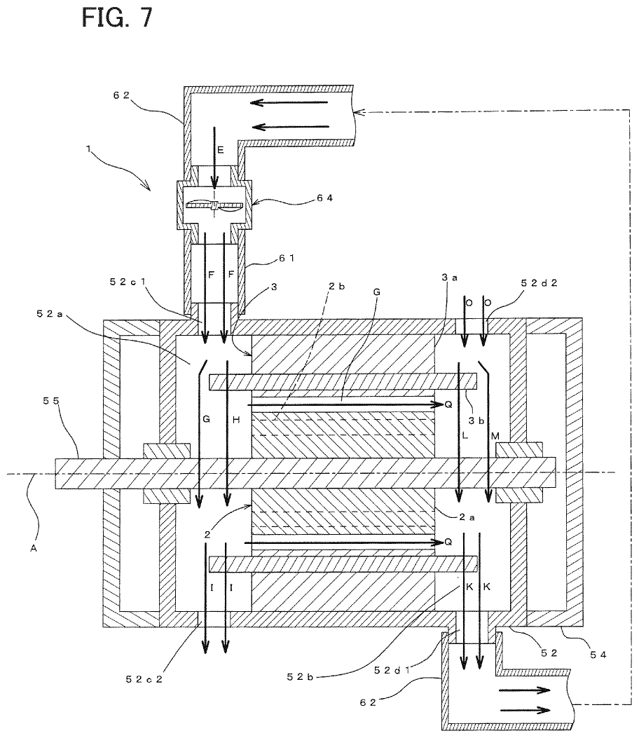

FIG. 7 is a cross-sectional view illustrating a longitudinal cross section of a motor 1 according to Example 2 together with a flow of air. In the motor 1 according to Example 2, similarly to the motor 1 according to the embodiment, the forced inflow hole 52c1 and the natural intake hole 52d2 are disposed on one side in the radial direction, and the natural exhaust hole 52c2 and the forced exhaust hole 52d1 are disposed on the other side in the radial direction. The motor 1 includes only the first airflow generator 64 as an airflow generator.

An intake port of the first airflow generator 64 is connected to the forced exhaust hole 52d1 through the second duct 62. The first airflow generator 64 supplies air into the one-side space 52a through the forced inflow hole 52c1, while sucking in the air in the other-side space 52b through the forced exhaust hole 52d1.

In such a configuration, only one first airflow generator 64 is used to forcibly allow air to flow into the one-side space 52a and forcibly exhaust air from the other-side space 52b, so that the number of airflow generators can be reduced to achieve cost reduction.

Note that, since the motor 1 according to the embodiment uses two airflow generators (64, 65), the cost is higher than that of the motor 1 according to Example 2, but there is an advantage that occurrence of downtime of the motor 1 due to a failure of the airflow generator can be suppressed. For example, in a case where the first airflow generator 64 fails, the motor 1 can be operated by connecting an exhaust port of the second airflow generator 64 and the forced inflow port 52c1 by a hypothetical duct during a period until the first airflow generator 64 is restored. Further, in a case where the second airflow generator 65 fails, the motor 1 can be operated by connecting the intake port of the first airflow generator 65 and the forced exhaust hole 52d1 by a hypothetical duct during a period until the second airflow generator 65 is restored.

### Example 3

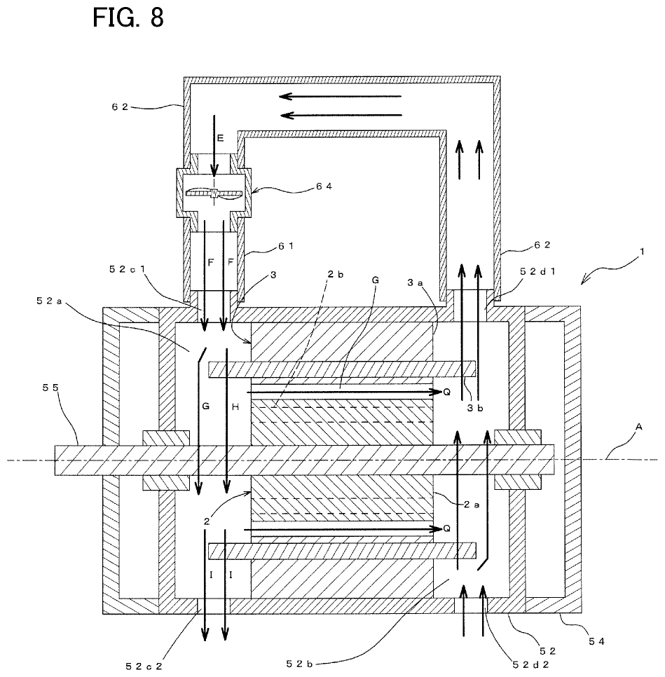

FIG. 8 is a cross-sectional view illustrating a longitudinal cross section of a motor 1 according to Example 3 together with a flow of air. In the motor 1 according to Example 3, similarly to the motor 1 according to Example 1, the forced inflow hole 52c1 and the forced exhaust hole 52d1 are disposed on one side in the radial direction, and the natural exhaust hole 52c2 and the natural intake hole 52d2 are disposed on the other side in the radial direction. Further, similarly to the motor 1 according to Example 2, the motor 1 according to Example 3 includes only the first airflow generator 64 as an airflow generator.

An intake port of the first airflow generator 64 is connected to the forced exhaust hole 52d1 through the second duct 62. The first airflow generator 64 supplies air into the one-side space 52a through the forced inflow hole 52c1, while sucking in the air in the other-side space 52b through the forced exhaust hole 52d1.

In such a configuration, it is possible to reduce the number of airflow generators to achieve cost reduction, similarly to the motor 1 according to Example 2, while suppressing generation of a dead space, similarly to the motor 1 according to Example 1.

### Example 4

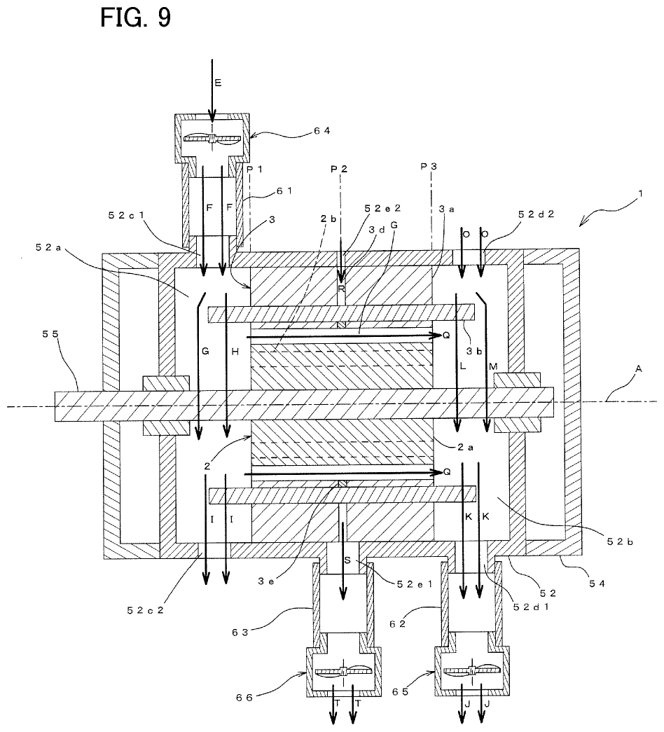

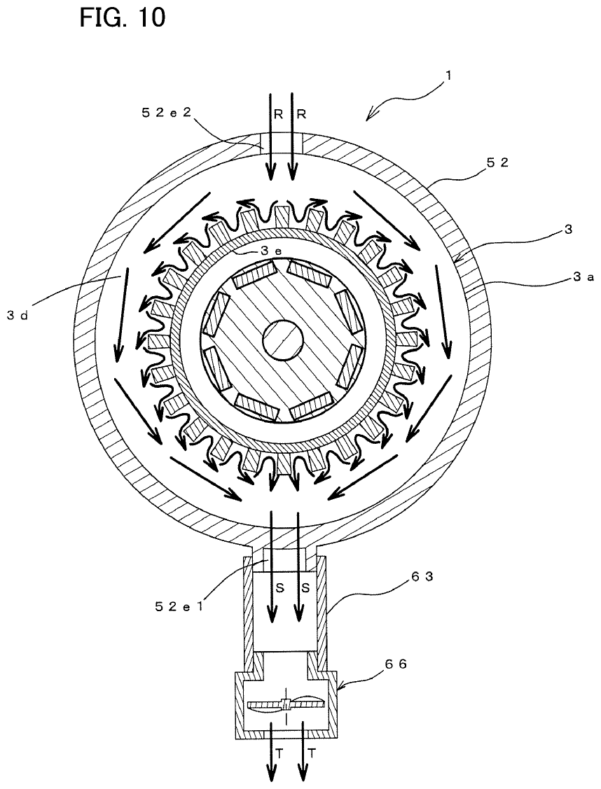

FIG. 9 is a cross-sectional view illustrating a longitudinal cross section of a motor 1 according to Example 4 together with a flow of air. FIG. 10 is a cross-sectional view illustrating a cross section of a main part of the motor 1 according to Example 4 together with a flow of air. Note that, FIG. 10 illustrates a fracture surface at a position where a second forced exhaust hole (52e1) to be described later exists in the entire area of the housing 52 in the axial direction.

The motor 1 according to Example 4 includes a third airflow generator 66. In FIG. 9, a reference sign P1 indicates one end position in the entire area of the stator core 3a of the stator 3 in the axial direction. Further, a reference sign P2 indicates a midpoint position in the entire area of the stator core 3a in the axial direction. Further, a reference sign P3 indicates the other end position in the entire area of the stator core 3a in the axial direction.

The stator core 3a includes an air circulation passage 3d extending over the entire area in the circumferential direction between the one end position P1 and the other end position P3. This air circulation passage exists on the midpoint position P2, and extends over the entire area of the stator core 3a in the circumferential direction as shown in FIG. 10. An other-end-side communication hole denoted by a reference sign 52d1 is given a name of forced exhaust hole in the embodiment, but in Example 4, the other end side communication hole is given a name of first forced exhaust hole in order to be clearly distinguished from a second forced exhaust hole (52e1) to be described later. Since the forced exhaust hole and the first forced exhaust hole are substantially the same communication hole, the forced exhaust hole and the first forced exhaust hole have the same roles as each other. Further, an other-end-side communication hole denoted by a reference sign 52d2 is given a name of natural intake hole in the embodiment, but in Example 4, the other end side communication hole is given a name of first natural intake hole in order to be clearly distinguished from a second natural intake hole (52e2) to be described later. Since the natural intake hole and the first natural intake hole are substantially the same communication hole, the natural intake hole and the first natural intake hole have the same role as each other.

The housing 52 includes a second forced exhaust hole 3e1 and a second natural intake hole 3e2. As shown in FIG. 10, the second forced exhaust hole 3e1 allows the outside of the housing 52 and the air circulation passage 3d of the stator core 3a to communicate with each other on one side in the radial direction. The second natural intake hole 3e2 allows the outside of the housing 52 and the air circulation passage 3d of the stator core 3a to communicate with each other on the other side in the radial direction.

In FIG. 9, the forced inflow hole 52c1, a second natural intake hole 52e2, and a first natural intake hole 52d2 are located on the same imaginary line segment extending in the axial direction. Further, the natural exhaust hole 52c2, a second forced exhaust hole 52e1, and a first forced exhaust hole 52d1 are located on the same imaginary line segment extending in the axial direction.

At the central portion of the housing 52 in the axial direction, the third airflow generator 66 and the second forced exhaust hole 52e1 of the housing 52 communicate with each other via a third duct 63. The third airflow generator 66 sucks in the air in the air circulation passage 3d of the stator core 3a through its own suction port, the third duct 63, and the second forced exhaust hole 52e1 of the housing 52 as indicated by an arrow S while exhausting air from its own air supply port as indicated by an arrow T. By this suction, the air in the air circulation passage 3d is forcibly exhausted through the second forced exhaust hole 52e1. Thereafter, the air is exhausted to the outside through the third duct 63 and the suction port and the air supply port of the third airflow generator 66.

When the air near the second forced exhaust hole 52e1 is exhausted to the third duct 63 through the second forced exhaust hole 52e1 in the air circulation passage 3d of the stator core 3a, the air in the air circulation passage 3d moves from the side of the second natural intake hole 52e2 toward the side of the second forced exhaust hole 52e1 as indicated by a thick arrow in FIG. 10. Due to the negative pressure generated by this movement, air outside the housing 52 naturally flows into the air circulation passage 3d of the stator core 3a through the second natural intake hole 52e2 of the housing 52.

The central portion of each of the housing 52, the rotor 2, the stator 3, and the shaft 55 in the axial direction is cooled by the air flowing in the air circulation passage 3d.

As shown in FIG. 9, the coil 3b extends in a straight line without being interrupted on the way from the one-end-side coil end portion to the other end side coil end portion. As shown in FIG. 10, at the central portion of the coil 3b in the axial direction, the central portion of each of the plurality of coils 3b in the axial direction is cooled by the air flowing in the air circulation passage 3d, whereby the stator 3 is efficiently cooled.

Each of the forced inflow hole 52c1, the first natural intake hole 52d2, and the second natural intake hole 52e2 is disposed on one side in the radial direction, and each of the natural exhaust hole 52c2, the first forced exhaust hole 52d1, and the second forced exhaust hole 52e1 is disposed on the other side in the radial direction. More specifically, each of the first natural intake hole 52d2 and the second natural intake hole 52e2 exists at a position shifted by 180 [° ] from each of the natural exhaust hole 52c2, the first forced exhaust hole 52d1, and the second forced exhaust hole 52e1 in the circumferential direction.

In such a configuration, in the one-side space 52a, an air pressure gradient gradually increasing from the side of the forced inflow hole 52c1 toward the side of the natural exhaust hole 52c2 is formed at a uniform rate of increase over the entire area from the side of the forced inflow hole 52c1 to the side of the natural exhaust hole 52c2. As a result, according to the motor 1 according to Example 4, air can flow with a uniform air flow rate over the entire area of the area described above in the one-side space 52a.

Further, in the air circulation passage 3d of the stator core 3a, an air pressure gradient gradually decreasing from the side of the second natural intake hole 52e2 toward the side of the second forced exhaust hole 52e1 is formed at a uniform rate of decrease over the entire area from the side of the second natural intake hole 52e2 to the side of the second forced exhaust hole 52e1. As a result, according to the motor 1 according to Example 4, air can flow with a uniform air flow rate over the entire area of the area described above in the air circulation passage 3d.

Further, In the other-side space 52b, an air pressure gradient gradually decreasing from the side of the first natural intake hole 52d2 toward the side of the first forced exhaust hole 52d1 is formed at a uniform rate of decrease over the entire area from the side of the first natural intake hole 52d2 to the side of the first forced exhaust hole 52d1. As a result, according to the motor 1 according to Example 1, air can flow with a uniform air flow rate over the entire area of the area described above in the other-side space 52b.

The stator 3 includes a partition part 3e in a ring shape that partitions the air circulation passage 3d and the gap G. The partition part 3e is made of a member different from the stator core 3a, and is made of a nonmagnetic material. The partition part 3e is disposed so as to be sandwiched between the other end face of each of the plurality of teeth (3c in FIG. 3) that exist on one end side of the stator core 3a in the axial direction and one end face of each of the plurality of teeth that exist on the other end side in the axial direction. Then, the partition part 3e is fixed to each of the other end face and the one end face described above.

In a case where the partition part 3e in a ring shape does not exist, the air circulation passage 3d of the stator core 3a and the gap G communicate with each other. Then, depending on the degree of the negative pressure in the other-side space 52b, there is a possibility that the airflow from the side of the one end position P1 toward the side of the midpoint position P2 in the gap G along the axial direction flows into the air circulation passage 3d of the stator core 3a. In a case where inflow described above occurs, an airflow flowing from the midpoint position P2 to the other end position P3 in the gap G is not generated, or the airflow described above decreases, so that the cooling efficiency of the portion on the other side of each of the housing 52, the rotor 2, and the stator 3 in the axial direction decreases.

In the motor 1 according to Example 4, by preventing inflow of air from the air circulation passage 3d to the gap G by the partition part 3e, it is possible to avoid a decrease in cooling efficiency of the portion on the other side of each of the housing 52, the rotor 2, and the stator 3 in the axial direction due to the inflow.

### Example 5

Unless otherwise specially noted below, the configuration of a motor 1 according to Example 5 is similar to the configuration of the motor 1 according to Example 4.

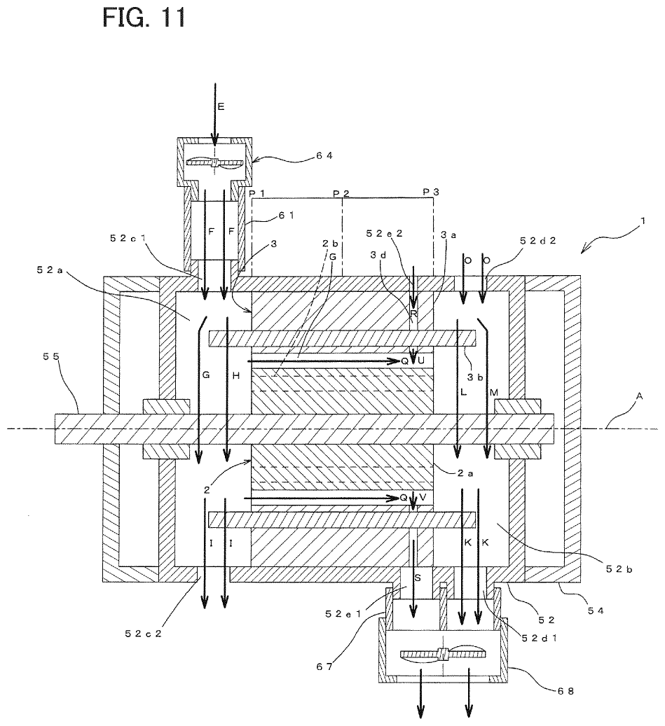

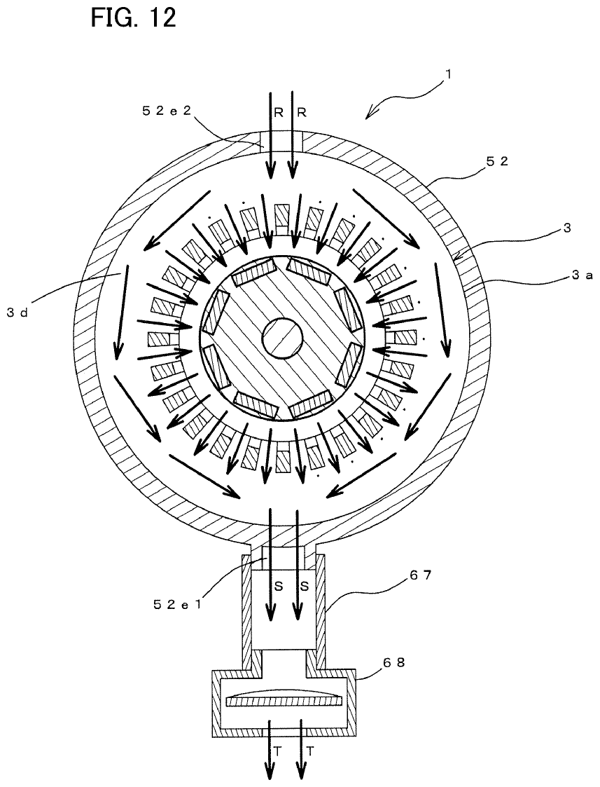

FIG. 11 is a cross-sectional view illustrating a longitudinal cross section of a motor 1 according to Example 5 together with a flow of air. FIG. 12 is a cross-sectional view illustrating a cross section of a main portion of the motor 1 according to Example 5 together with a flow of air. Note that, FIG. 12 illustrates a fracture surface at a position where the second forced exhaust hole 52e1 exists in the entire area of the housing 52 in the axial direction.

The stator core 3a does not include a partition part that partitions the air circulation passage 3d and the gap G. For this reason, the air circulation passage 3d and the gap G communicate with each other. A part of the air in the air circulation passage 3d flows into the gap G from the air circulation passage 3d in an area of the air circulation passage 3d on the side of the second natural intake hole 52e2. Further, a part of the air in the gap G flows into the air circulation passage 3d from the gap G in an area of the gap G on the side of the forced exhaust hole 52e1. The air in the air circulation passage 3d flows into a communication duct 67 from the air circulation passage 3d through the second forced exhaust hole 52e1 of the housing 52. The communication duct 67 communicates with both the first forced exhaust hole 52d1 and the second forced exhaust hole 52e1 of the housing 52 to function as a communication flow channel that allows the first forced exhaust hole 52d1 and the second forced exhaust hole 52e1 to communicate with each other.

As shown in FIG. 11, the airflow in the gap G flows from the one end position P1 to the other end position P3 via the midpoint position P2 in the axial direction, but flows into the air circulation passage 3d of the stator core 3a before reaching the other end position P3. As a result, in the gap G, in the area from the position of the air circulation passage 3d to the other end position P3 in the axial direction, the airflow flowing in the gap G is not generated, or the air flow rate decreases. As a result, in the portion from the position of the air circulation passage 3d to the other end position P3 of the rotor 2 and the stator 3 in the axial direction, the cooling efficiency due to the airflow in the gap G decreases as compared with the other portions, however, since an axial length of the former portion is very short, the overall cooling efficiency of each of the rotor 2 and the stator 3 only slightly decreases to a negligible extent.

According to such a configuration, it is possible to suppress a decrease in cooling efficiency due to the air in the air circulation passage 3d flowing into the gap G while reducing the cost by omitting attachment of the partition part (3e).

The air in the communication duct 67 is exhausted to the outside by driving of a shared airflow generator 68. The shared airflow generator 68 shares the second airflow generator (65) and the third airflow generator (66) in Example 4 as one individual. In such a configuration, the number of airflow generators can be reduced to achieve cost reduction.

Note that, instead of providing the communication duct 67 and the shared airflow generator 68, the second duct (62), the second airflow generator (65), the third duct (63), and the third airflow generator (66) may be provided as in Example 4.

An example in which the present invention is applied to the motor 1 as a rotary machine has been described above, but the present invention may be applied to a generator (a dynamo) as a rotary machine. Further, a type of the rotary machine according to the present invention is not limited to an interior permanent magnet (IPM). A type such as a surface permanent magnet (SPM) or an induction motor (IM) may be used, and any type may be used as long as it is a rotary machine using a stator that has a coil end.

The present invention is not limited to the embodiment described above and each example, and a configuration different from the embodiment and each example can be adopted within a range where the configuration of the present invention can be applied. The present invention has a specific action effect for each aspect described below.

### [First Aspect]

A first aspect is a rotary machine (for example, a motor 1) that includes a stator (for example, a stator 3), a rotatable rotor (for example, a rotor 2) disposed in a hollow space of the stator, and a housing (for example, a housing 52) that accommodates the stator and the rotor, the housing includes: a one-side space (for example, a one-side space 52a) that is disposed on one side in an axial direction relative to the rotor and communicates with a gap (for example, a gap G) between an inner peripheral surface of the stator and an outer peripheral surface of the rotor; an other-side space (for example, an other-side space 52b) that is disposed on the other side in the axial direction relative to the rotor and communicates with the gap; a one-side communication hole that allows outside of the housing and the one-side space to communicate with each other; and an other-side communication hole that allows the outside of the housing and the other-side space to communicate with each other, the one-side space and the other-side space communicates with each other through the gap, and each of the one-side communication hole and the other-side communication hole is connected to an airflow generator (for example, a first airflow generator 64 and a second airflow generator 65) that generates an airflow, the rotary machine includes, as the one-side communication hole, a forced inflow hole (for example, a forced inflow hole 52c1) that causes air outside the housing to forcibly flows into inside of the one-side space by the airflow generator, and a natural exhaust hole (for example, a natural exhaust hole 52c2) through which air inside the one-side space is naturally exhausted, and includes, as the other-side communication hole, a forced exhaust hole (for example, a forced exhaust hole 52d1) that causes the airflow generator to forcibly exhaust air inside the other-side space, and a natural intake hole (for example, a natural intake hole 52d2) through which air outside the housing 52 is naturally sucked into the inside of the other-side space.

According to such a configuration, it is possible to cool a central portion of each of the stator and the rotor in the axial direction by an airflow in the gap without causing a decrease in cooling efficiency caused by reducing an air supply amount by the second airflow generator as compared with the air supply amount by the first airflow generator.

### [Second Aspect]

A second aspect is a rotary machine that includes the configuration of the first aspect, and, in which the forced inflow hole and the natural intake hole are disposed on one side in a radial direction, and the natural exhaust hole and the forced exhaust hole are disposed on the other side in the radial direction.

According to the second aspect of such a configuration, as described in the embodiment, an air flow rate from one side to the other side in the gap between the inner peripheral surface of the stator and the outer peripheral surface of the rotor can be made uniform in a circumferential direction.

### [Third Aspect]

A third aspect is a rotary machine that includes the configuration of the second aspect, and, in which the forced inflow hole and the forced exhaust hole are disposed on one side in the radial direction, and the natural exhaust hole and the natural intake hole are disposed on the other side in the radial direction.

According to the third aspect of such a configuration, as described in Example 1, an installation area of the rotary machine including the airflow generator can be reduced as compared with a case where the airflow generator is disposed on one side and the other side in the radial direction (FIG. 2).

### [Fourth Aspect]

A fourth aspect is a rotary machine that includes the configuration of the second aspect or the third aspect, and includes, as the airflow generator, a first airflow generator that supplies air into the one-side space through the forced inflow hole, and a second airflow generator that sucks in the air in the other-side space through the forced exhaust hole.

According to the fourth aspect of such a configuration, by providing the two airflow generators, it is possible to suppress occurrence of downtime of the rotary machine due to a failure of the airflow generator.

### [Fifth Aspect]

A fifth aspect is a rotary machine that includes the configuration of the second aspect or the third aspect, and, in which the airflow generator supplies air into the one-side space through the forced inflow hole while sucking in the air in the other-side space through the forced exhaust hole.

According to the fifth aspect of such a configuration, as described in Example 2, the number of airflow generators can be reduced to achieve cost reduction.

### [Sixth Aspect]

A sixth aspect is a rotary machine that includes the configuration of the fourth aspect and a third airflow generator, in which a stator core (for example, a stator core 3a) of the stator includes an air circulation passage (for example, an air circulation passage 3d) extending over an entire area in a circumferential direction between one end and the other end in the axial direction, the forced exhaust hole is a first forced exhaust hole (for example, a first forced exhaust hole 52d1), the natural intake hole is a first natural intake hole (for example, a first natural intake hole 52d2), and the housing includes a second forced exhaust hole (for example, a second forced exhaust hole 52e1) that causes the third airflow generator to forcibly exhaust air inside the air circulation passage while allowing the outside of the housing 52 and the air circulation passage to communicate with each other on one side in the radial direction, and a second natural intake hole (for example, a second natural intake hole 52e2) through which air outside the housing 52 is naturally sucked into the inside of the air circulation passage.

According to the sixth aspect of such a configuration, it is possible to cool the central portion of each of the rotor and the stator in the axial direction by the air flowing in the air circulation passage.

In addition, according to the sixth aspect, in the one-side space, an air pressure gradient with a uniform rate of increase is formed over the entire area from a side of the natural exhaust hole to a side of the forced inflow hole, and the intake air can flow with a uniform air flow rate over the entire area of the area described above.

In addition, according to the sixth aspect, in the air circulation passage, an air pressure gradient with a uniform rate of decrease is formed over the entire area from the side of the second natural intake hole to the side of the second forced exhaust hole, and the air can flow with a uniform air flow rate over the entire area of the area described above.

In addition, according to the sixth aspect, in the other-side space, an air pressure gradient with a uniform rate of decrease is formed over the entire area from the side of the first natural intake hole to the side of the first forced exhaust hole, and the air can flow with a uniform air flow rate over the entire area of the area described above.

### [Seventh Aspect]

A seventh aspect is a rotary machine that includes the configuration of the sixth aspect, and, in which the stator includes a plurality of coils (for example, coils 3b) wound around the stator core, and a central portion of each of the plurality of coils in the axial direction is located inside the air circulation passage.

According to the seventh aspect of such a configuration, the stator can be efficiently cooled by directly cooling the center portion of the coils in the axial direction by the air flowing in the air circulation passage 3d.

### [Eighth Aspect]

An eighth aspect is a rotary machine that includes the configuration of the seventh aspect, and, in which the stator includes a partition part (for example, a partition part 3e) that partitions the air circulation passage and the gap.

According to the eighth aspect of such a configuration, by preventing inflow of air from the air circulation passage to the gap by the partition part, it is possible to avoid a decrease in cooling efficiency of a portion on other side of each of the housing, the rotor, and the stator in the axial direction due to the inflow.

### [Ninth Aspect]

A ninth aspect is a rotary machine that includes the configuration of the eighth aspect, and, in which the partition part is made of a nonmagnetic material.

According to the ninth aspect of such a configuration, generation of eddy currents in the stator can be suppressed as compared with a case where the partition part is made of a magnetic material.

### [Tenth Aspect]

A tenth aspect is a rotary machine that includes the configuration to the sixth aspect or the seventh aspect, and, in which the air circulation passage communicates with the gap, and each of the second forced exhaust hole and the air circulation passage is disposed at a position shifted to the other side from an axial midpoint (for example, a midpoint position P2) of the stator in the axial direction.

According to the tenth aspect of such a configuration, it is possible to suppress a decrease in cooling efficiency due to the air in the air circulation passage flowing into the gap while reducing the cost by omitting attachment of the partition part described above.

### [Eleventh Aspect]

An eleventh aspect is a rotary machine that includes the configuration of the tenth aspect, and includes a communication flow channel (for example, a communication duct 67) that allows the first forced exhaust hole and the second forced exhaust hole to communicate with each other, in which the second airflow generator and the third airflow generator are configured by one shared airflow generator (for example, a shared airflow generator 68) that sucks in the air in the communication flow channel.

According to the eleventh aspect of such a configuration, the number of airflow generators can be reduced to achieve cost reduction.

The present application claims priority based on Japanese Patent Application No. 2021-077309 filed on Apr. 30, 2021, the entire contents of which are incorporated herein by reference.

### INDUSTRIAL APPLICABILITY

The present invention is applicable to a rotary machine such as a motor and a dynamo.

### REFERENCE SIGNS LIST

2 Rotor
2a Rotor core
2b Permanent magnet
3 Stator
3a Stator core
3b Coil
3c Tooth
3d Air circulation passage
3e Partition part
52 Housing
52a One-side space
52b Other-side space
52c One-side communication hole
52c1 Forced inflow hole
52c2 Natural exhaust hole
52d Other-side communication hole
52d1 Forced exhaust hole (first forced exhaust hole)
52d2 Natural intake hole (first natural intake hole)
52e1 Second forced exhaust hole
52e21 Second natural intake hole
61 First duct
62 Second duct
63 Third duct
64 First airflow generator
65 Second airflow generator
66 Third airflow generator
67 Communication duct (communication flow channel)
68 Shared airflow generator

1. A rotary machine comprising: a stator; a rotatable rotor disposed in a hollow space of the stator; and a housing that accommodates the stator and the rotor, wherein
the housing includes:
a one-side space disposed on one side in an axial direction relative to the rotor and communicating with a gap between an inner peripheral surface of the stator and an outer peripheral surface of the rotor;
an other-side space disposed on the other side in the axial direction relative to the rotor and communicating with the gap;
a one-side communication hole that allows outside of the housing and the one-side space to communicate with each other; and
an other-side communication hole that allows the outside of the housing and the other-side space to communicate with each other,
the one-side space and the other-side space communicate with each other via the gap,
each of the one-side communication hole and the other-side communication hole is connected to an airflow generator that generates an airflow,
the rotary machine includes, as the one-side communication hole, a forced inflow hole that causes air outside the housing to forcibly flow into inside of the one-side space by the airflow generator, and a natural exhaust hole through which air inside the one-side space is naturally exhausted, and
the rotary machine includes, as the other-side communication hole, a forced exhaust hole that causes the airflow generator to forcibly exhaust air inside the other-side space, and a natural intake hole through which air outside the housing is naturally sucked into the inside of the other-side space.

2. The rotary machine according to claim 1, wherein
the forced inflow hole and the natural intake hole are disposed on one side in a radial direction, and
the natural exhaust hole and the forced exhaust hole are disposed on the other side in the radial direction.

3. The rotary machine according to claim 1, wherein
the forced inflow hole and the forced exhaust hole are disposed on one side in the radial direction, and
the natural exhaust hole and the natural intake hole are disposed on the other side in the radial direction.

4. The rotary machine according to claim 2, further comprising
as the airflow generator, a first airflow generator that supplies air into the one-side space through the forced inflow hole, and a second airflow generator that sucks in the air in the other-side space through the forced exhaust hole.

5. The rotary machine according to claim 2, wherein
the airflow generator supplies air into the one-side space through the forced inflow hole while sucking in the air in the other-side space through the forced exhaust hole.

6. The rotary machine according to claim 4, further comprising
a third airflow generator, wherein
a stator core of the stator includes an air circulation passage extending over an entire area in a circumferential direction between one end and the other end in the axial direction,
the forced exhaust hole is a first forced exhaust hole,
the natural intake hole is a first natural intake hole, and
the housing includes a second forced exhaust hole that causes the third airflow generator to forcibly exhaust air inside the air circulation passage while allowing the outside of the housing and the air circulation passage to communicate with each other on one side in the radial direction, and a second natural intake hole through which air outside the housing is naturally sucked into the inside of the air circulation passage.

7. The rotary machine according to claim 6, wherein
the stator includes a plurality of coils wound around the stator core, and
a central portion of each of the plurality of coils in the axial direction is located inside the air circulation passage.

8. The rotary machine according to claim 7, wherein
the stator includes a partition part that partitions the air circulation passage and the gap.

9. The rotary machine according to claim 8, wherein
the partition part is made of a nonmagnetic material.

10. The rotary machine according to claim 6, wherein
the air circulation passage communicates with the gap, and
each of the second forced exhaust hole and the air circulation passage is disposed at a position shifted to the other side from an axial midpoint of the stator in the axial direction.

11. The rotary machine according to claim 10, further comprising
a communication flow channel that allows the first forced exhaust hole and the second forced exhaust hole to communicate with each other, wherein
the second airflow generator and the third airflow generator are configured by one shared airflow generator that sucks in the air in the communication flow channel.

12. The rotary machine according to claim 3, further comprising
as the airflow generator, a first airflow generator that supplies air into the one-side space through the forced inflow hole, and a second airflow generator that sucks in the air in the other-side space through the forced exhaust hole.

13. The rotary machine according to claim 3, wherein
the airflow generator supplies air into the one-side space through the forced inflow hole while sucking in the air in the other-side space through the forced exhaust hole.

14. The rotary machine according to claim 12, further comprising
a third airflow generator, wherein
a stator core of the stator includes an air circulation passage extending over an entire area in a circumferential direction between one end and the other end in the axial direction,
the forced exhaust hole is a first forced exhaust hole,
the natural intake hole is a first natural intake hole, and
the housing includes a second forced exhaust hole that causes the third airflow generator to forcibly exhaust air inside the air circulation passage while allowing the outside of the housing and the air circulation passage to communicate with each other on one side in the radial direction, and a second natural intake hole through which air outside the housing is naturally sucked into the inside of the air circulation passage.

15. The rotary machine according to claim 14, wherein
the stator includes a plurality of coils wound around the stator core, and
a central portion of each of the plurality of coils in the axial direction is located inside the air circulation passage.

16. The rotary machine according to claim 15, wherein
the stator includes a partition part that partitions the air circulation passage and the gap.

17. The rotary machine according to claim 16, wherein
the partition part is made of a nonmagnetic material.

18. The rotary machine according to claim 14, wherein
the air circulation passage communicates with the gap, and
each of the second forced exhaust hole and the air circulation passage is disposed at a position shifted to the other side from an axial midpoint of the stator in the axial direction.

19. The rotary machine according to claim 18, further comprising
a communication flow channel that allows the first forced exhaust hole and the second forced exhaust hole to communicate with each other, wherein
the second airflow generator and the third airflow generator are configured by one shared airflow generator that sucks in the air in the communication flow channel.
